(19) United States
(12) Patent Application Publication
(10) Pub. No.: US 2005/0023058 A1
(43) Pub. Date: Feb. 3, 2005

(54) Method for providing acceleration in a multiple torque source powertrain to simulate a single torque source powertrain

(76) Inventors: Brian P. Gebby, Ferndale, MI (US); Thomas S. Moore, Oxford, MI (US); Gerald Cilibraise, Livonia, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/630,177

(22) Filed: Jul. 30, 2003

(51) Int. Cl. B60K 5/08

(52) U.S. Cl. 180/69.6; 60/706

(57) ABSTRACT

A method for accelerating a motor vehicle having multiple torque sources including a first torque source and a second torque source that each provide a torque output in order to simulate a single torque source engine. The method includes determining an acceleration request. The acceleration request is compared to a data store of target torque outputs associated with torque output from the single torque source engine. A target torque output based on the acceleration request is selected. The torque output from the first torque source is increased to the target torque output if the first torque source can meet the target torque output. The combined torque output from the first and second torque sources is increased to the target torque output if the first torque source cannot meet the target torque output.

### FIELD OF THE INVENTION

The present invention relates to a method for providing acceleration in a powertrain and more particularly to a method for providing acceleration in a multiple torque source powertrain to simulate a single torque source powertrain.

### BACKGROUND OF THE INVENTION

Engines in current production automobiles are typically sized to meet certain performance requirements. For normal city and highway driving, the engine is operated at low loads (e.g. at a partial torque output), which in turn leads to low engine efficiency and therefore high fuel consumption. Several approaches have been proposed to modify the powertrain of a vehicle to achieve higher engine efficiency during low loads. One such solution is disclosed in commonly assigned U.S. Pat. No. 6,306,056 to Moore, herein incorporated by reference as if fully set forth herein. '056 to Moore discloses a hybrid vehicle having multiple separate torque sources coupled to a conventional automatic transmission. When the vehicle is operated at a relatively low rate of speed, only one of the torque sources is employed to propel the vehicle. When the torque demand exceeds the single torque source's maximum torque output, a second torque source is activated and engaged to the transmission, and synchronized with the first torque source. However, a motor vehicle operating with only one torque source in a powertrain having multiple torque sources does not have the same torque as a relatively large single torque source engine.

### SUMMARY OF THE INVENTION

A method for accelerating a motor vehicle having a multiple torque source engine in order to simulate a single torque source engine is provided. The multiple torque source engine includes a first torque source and a second torque source that each provide a torque output. The method comprises first determining an acceleration request. Then, the acceleration request is compared to a data store of target torque outputs associated with torque output from the single torque source engine. A target torque output based on the acceleration request is selected. The torque output from the first torque source is increased to the target torque output if the first torque source can meet the target torque output. The combined torque output from the first and second torque sources is increased to the target torque output if the first torque source cannot meet the target torque output.

Further areas of applicability of the present invention will become apparent from the detailed description provided hereinafter. It should be understood that the detailed description and specific examples, While indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of a motor vehicle having a powertrain constructed according to the principles of the present invention;

FIG. 2 is a schematic diagram of the control system for the powertrain constructed according to the principles of the present invention; and

FIG. 3 is a flowchart illustrating a methodology for accelerating the powertrain of the present invention.

### DETAILED DESCRIPTION OF THE PREFERRED EMBODIMENTS

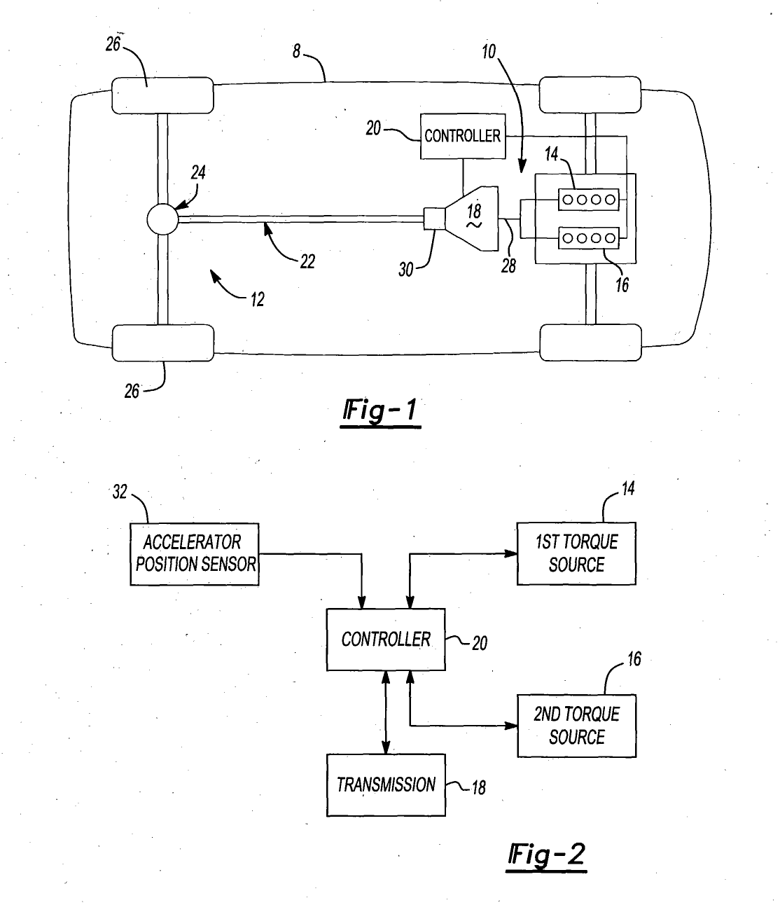

Referring to FIG. 1 of the drawings, a motor vehicle 8 is illustrated with a powertrain 10 constructed according to the principles of the present invention. The motor vehicle 8 further includes a driveline 12 driven by the powertrain 10. Those skilled in the art will appreciate that the incorporation of the powertrain 10 into the motor vehicle 8 is merely exemplary in nature and that the powertrain 10 has applicability to various other environments, for example motorboats.

The powertrain 10 includes a first torque source 14, a second torque source 16, a transmission 18, and a controller 20. The first and second torque sources 14, 16 are each illustrated as 4-cylinder gasoline engines. However, it is to be understood that various gasoline engines may be employed each having any number of cylinders. Furthermore, any number of multiple torque sources may be included in the powertrain 10.

The driveline 12 includes a propshaft assembly 22 coupled to an axle assembly 24. The axle assembly 24 is in turn coupled to a pair of wheels 26.

The output of the first and second torque sources 14, 16 is selectively coupled via a conventional clutch (not specifically shown) to an input 28 of the transmission 18 in order to transmit rotary torque therebetween. The transmission 18 further includes an output 30 coupled for rotation to the propshaft assembly 22. Drive torque is transmitted through the propshaft assembly 22 to the rear axle 24 where it is selectively transferred to the pair of wheels 26.

With reference now to FIG. 2, the controller 20 is in communication with the first torque source 14, the second torque source 16, the transmission 18, as well as an accelerator sensor 32. The accelerator sensor 32 is coupled to the accelerator (not specifically shown) of the motor vehicle 8 and operates to signal to the controller 20 the position of the accelerator. The controller 20 is preferably an electronic microprocessor unit.

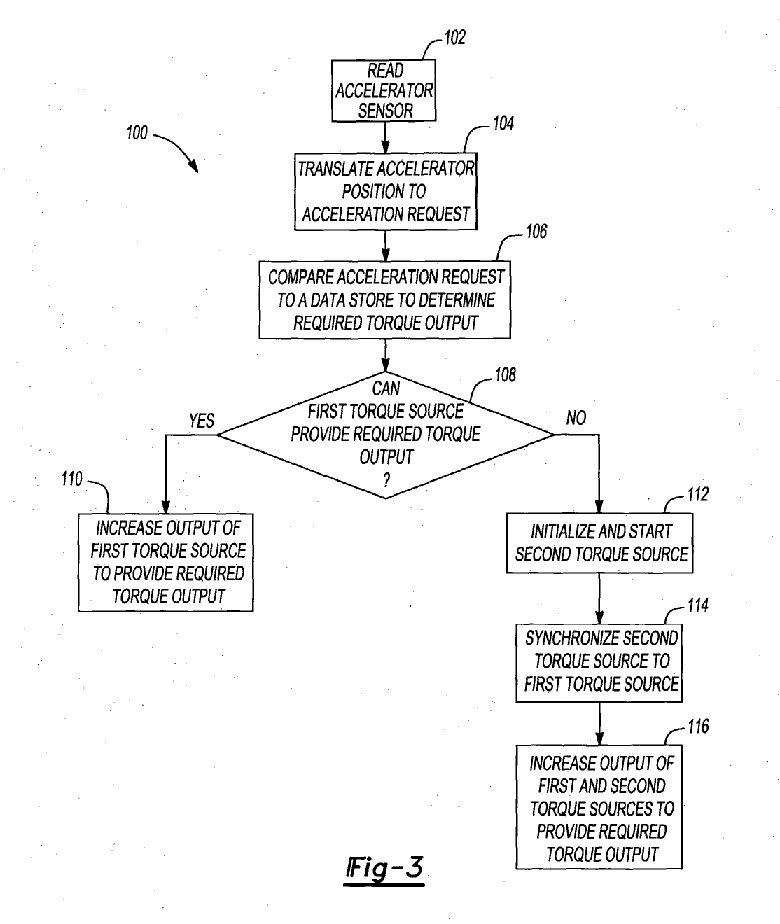

Turning now to FIG. 3, a method for providing acceleration to the powertrain 10 according to the principles of the present invention is indicated generally by reference numeral 100. Initially only one of the torque sources 14, 16 (e.g., the first torque source 14) is engaged with the transmission 18 and providing rotational torque output to the driveline 22. The method 100 begins by reading the accelerator position sensor 32 at step 102. The controller 20 then translates the accelerator position to an acceleration request at step 104.

The acceleration request is then compared to a data store to determine a required torque output, shown at step 106. The data store contains acceleration requests that are each associated with a target torque output. The target torque output is defined as the amount of torque output that would be provided from a conventional single torque source combustion engine given the associated acceleration request. For example, the target torque outputs may be derived from the torque output of a typical 8-cylinder, or V8, gasoline engine under various acceleration requests. The required torque output is the target torque output associated with the acceleration request as determined in step 104.

As mentioned above, only the first torque source 14 is engaged at this point to the transmission 18 and providing rotational output to the driveline 22. The controller 20 determines if the first torque source 14 is capable of meeting the required torque output, shown at step 108. Specifically, the controller 20 knows the maximum torque output of the first torque source 14. It then compares the maximum torque output to the required torque output to determine if the first torque source 14 can provided the required torque output.

If the first torque source 14 can provide the required torque output, then the controller 20 commands the first torque source 14 to provide the required torque output to the driveline 22, as shown in step 110. When providing the required torque output, the powertrain 10 simulates the torque output of a typical single torque source engine. By using a relatively smaller first torque source 14 to meet torque requirements of a larger single torque source engine, fuel efficiency is increased over the conventional larger engine.

If the first torque source 14 cannot provide the required torque output, then the controller 20 orders the second torque source 16 to initialize and start, as indicated at step 112. The second torque source 16 is then synchronized to the first torque source 14 at step 114. Synchronization of the second torque source 16 to the first torque source 14 may be accomplished using the method described in commonly assigned U.S. Pat. No. 6,474,068 BI, herein incorporated by reference in its entirety.

Once the second torque source 16 has been synchronized to the first torque source 14, the controller 20 orders the first and second torque sources 14, 16 to increase output to provide the required torque output, shown at step 116. As noted above, by meeting the required torque output, the powertrain 10 acts to replicate the output of a conventional single torque source combustion engine while simultaneously providing the efficiency benefits of a multiple torque source engine.

The description of the invention is merely exemplary in nature and, thus, variations that do not depart from the gist of the invention are intended to be within the scope of the invention. Such variations are not to be regarded as a departure from the spirit and scope of the invention.

1. A method for accelerating a motor vehicle having a multiple torque source engine in order to simulate the acceleration of a motor vehicle with a relatively larger single torque source engine the multiple torque source engine including a first torque source and a second torque source each providing a torque output, the method comprising:
determining an acceleration request;
comparing the acceleration request to a data store of target torque outputs associated with torque output from the single torque source engine;
selecting a target torque output based on the acceleration request;
increasing the torque output of the first torque source to the target torque output if the first torque source can meet the target torque output, thereby simulating the single torque source engine; and
increasing the combined torque output, of the first and second torque sources to the target torque output if the first torque source cannot meet the target torque output, thereby simulating the single torque source engine.

2. The method of claim 1, wherein determining an acceleration request includes reading an accelerator position sensor to determine an accelerator position and translating the accelerator position into the acceleration request.

3. The method of claim 1, wherein the data store contains a list of acceleration requests matched with target torque outputs, the target torque outputs identical to the torque outputs of the single torque source engine due to various acceleration requests.

4. The method of claim 1, wherein increasing the combined torque output of the first and second torque sources includes initializing and synchronizing the second torque source to the first torque source.
